(19) United States
(12) Patent Application Publication
(10) Pub. No.: US 2003/0070332 A1
(43) Pub. Date: Apr. 17, 2003

(54) Multipurpose display device and method of use

(76) Inventors: Cathy D. Santa Cruz, Reno, NV (US); James W. Hinton, Sparks, NV (US)

Correspondence Address: Cathy D. Santa Cruz, 7630 Tholl Drive, Reno, NV, 89506, US

(21) Appl. No.: 09/977,152

(22) Filed: Oct. 12, 2001

(51) Int. Cl. G09F 1/00

(52) U.S. Cl. 40/124.01

(57) ABSTRACT

A mounting card and method of use for displaying information thereon which is pertinent to a specific symbol, and when viewed automatically stimulates a human emotional response.

### FIELD OF THE INVENTION

This invention relates in general to display devices, such as signs, decals, stickers, etc., but more particularly pertains to a device that is used to display a message thereon in a manner that automatically stimulates an emotional human response when viewed. The device is aesthetically pleasing and depicts a well-known, easily recognized symbol thereon, such as a flag, a ribbon, a happy face, a dollar sign, or the like, and further includes a novel method of use.

### BACKGROUND OF THE INVENTION

In the past, numerous devices have been created and used for display of a message thereon. In most instances, such display devices typically include an informative message therewith such as “for sale”, “help wanted”, “open”, or “closed”, etc. However, in most cases these messages simply provide information and are not functional for invoking an emotional response when viewed, which is the intent and purpose of the present invention.

For example, most individuals will experience a warm happy feeling or humorous feeling when they visualize or see a “happy” or “smiley face”. When one visualizes or sees the American flag they automatically feel pride and patriotism. Therefore, the applicants contend there is a need for a display device which not only displays a message of some type, but involuntarily causes an emotional response and also includes means for informing the user of additional information regarding the message. For example, when the display device is first viewed, an emotional response is incurred, and this also further induces curiosity and desire for additional information regarding the message.

This is exemplified in the following embodiment wherein the display device is in the form of a patriotic bow, which induces a feeling of patriotism, and the display device further includes a removable informational strip, such as in the form of a black ribbon. Thus, when positioned onto the patriotic bow, this further informs the viewer that the United States is currently at war which causes yet another emotional response, such as hope or concern. Thereafter, when all the troops are safely back home and the war is over, the black ribbon when removed informs the viewer of such and this in turn causes happiness and relief.

It is to be understood that this is only one possible embodiment for the present invention as many other types of messages can be displayed, as well as many other types of emotions may be induced, depending on engineering and user choice.

### SUMMARY OF THE INVENTION

It is therefore an object of the present invention to provide a novel display device that not only displays a message thereon but also stimulates an emotional human response when viewed.

It is another object of the present invention to provide a novel display device that not only displays a message thereon but also allows a user to remove and position a removable informational strip, which provides additional information pertinent to the message displayed.

Yet another object of the present invention is to provide a novel display device that not only displays a message thereon but also provides the user with means to communicate with the viewer and inform the viewer of their personal feelings.

Still another object of the present invention is to provide a novel display device that may be manufactured substantially in the form of a card. With the card having a removable symbol thereon which can be removably attached onto an object of user choice. The card further providing an additional removable informational strip, with the strip having attachment means for removably attaching the strip onto the symbol or message.

Yet a further object of the present invention is to provide a novel display device wherein the above noted card, symbol, and strip can be made from substantially any suitable material of engineering choice. Such materials include cardboard, plastic, a magnetic film material, etc. or a combination of different materials.

Another object of the present invention is to provide a novel display device that can be sold as a kit, and provides instructions therewith. With the instructions clearly defining a novel specific method of use for the present invention.

A further object of the present invention is to provide a novel display device that is of very simple construction and is economical to manufacture, produce and sell.

Also, another object of the present invention is to provide a novel display device that may be made from an iridescent material or even a fluorescent material so as to glow in the dark, or the like.

Other objects and advantages will be seen when taken into consideration with the following specification and drawings.

### BRIEF DESCRIPTION OF THE DRAWINGS

FIG. 1 is substantially an overview for the preferred embodiment for the present invention and illustrates the front side of the display device.

FIG. 2 is substantially an overview for the present invention and illustrates the backside of the display device.

FIG. 3 is substantially a right side view of the preferred embodiment for the present invention.

### DETAILED DESCRIPTION OF THE DRAWINGS

Referring now in detail to the drawings wherein like characters refer to like elements throughout the various views. The present invention is substantially a novel display device (10) that can be used for limitless applications wherein a message is to be visually presented so as to induce a humane emotional response. Also, the display device (10) can be mounted or removably attached onto any suitable surface of user choice, such as onto a vehicle window, onto a sliding glass door, onto a refrigerator door, or even onto a T-shirt or the like.

Therefore, it is to be understood the following description only exemplifies one possible embodiment for the present invention, thus the invention is not to be limited thereto as the present invention can be utilized in numerous embodiments depending on engineering choice.

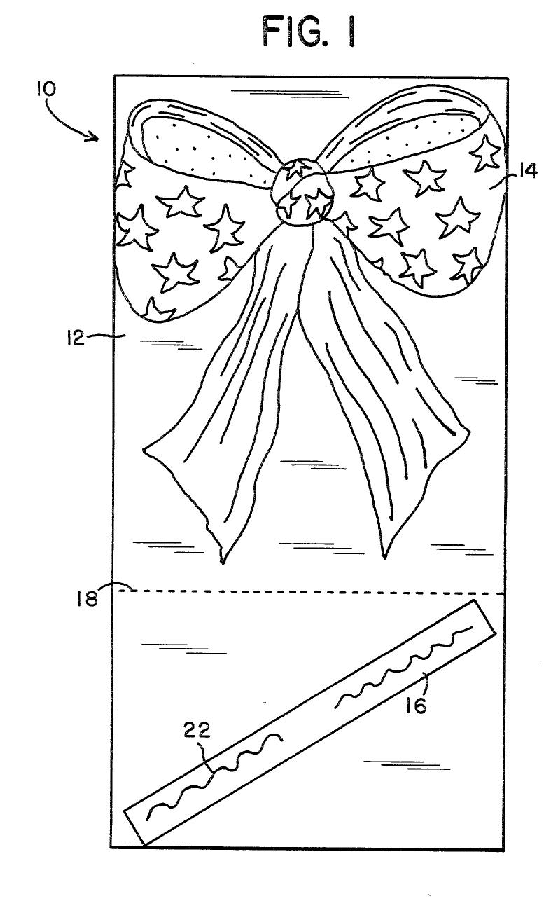

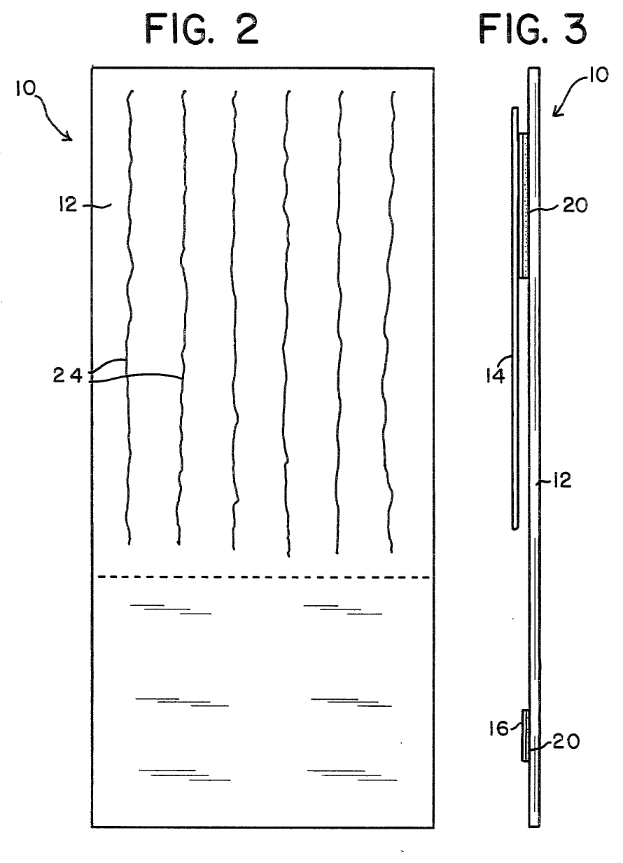

As depicted in FIGS. 1, 2, and 3 (10) represents an overview for the present novel display device which substantially comprises in combination a mounting card (12), a symbol (14) and a strip (16). The mounting card (12) having a front side as depicted in FIG. 1, and a back side as depicted in FIG. 2, with the front side being sectioned into an upper portion and a lower portion. Also, if so desired the mounting card (12) may include perforations (18) between the upper portion and the lower portion so as to allow the user to easily separate each portion from each other.

Symbol (14) includes attachment means for removably attaching symbol (14) onto the upper portion of mounting card (12) and strip (16) includes attachment means for removably attaching strip (16) onto the lower portion of mounting card (12). It is to be understood that any suitable attachment means of engineering choice may be used, such as a spray on adhesive (20) as depicted in FIG. 3, or tape, glue, staples, etc.

It is to be further understood that mounting card (12), symbol (14) and strip (16) can each be made from any suitable material of engineering choice, such as cardboard, plastic, etc. Or if desired, symbol (14) and strip (16) can be made from a flexible magnetic material, an iridescent material, or a combination of both. Still further if so desired, for novelty purposes, symbol (14) and strip (16) can each be made from a fluorescent material so as to glow in the dark.

Referring now to symbol (14), which can be any easily recognized type of engineering choice, such as in the form of an American flag, a “smiley face”, a dollar sign, etc. Or as the applicants prefer, a patriotic bow as depicted herein is very pleasing and most satisfactory. Also, if desired, symbol (14) may be made from fabric.

Referring now to strip (16) which again can be in the form of any suitable shape, size or color of engineering choice. Also, strip (16) includes indicia (22) thereon, which provides pertinent information relative to symbol (14). For example, strip (16) may include the words “LIBERTY AND JUSTICE”, or “UNITED WE STAND” or the like.

As illustrated in FIG. 2, the back side of mounting card (12) includes indicia (24) thereon which provides instructions for use of mounting card (12). It is to be understood that indicia (24) can be any suitable instructions of engineering choice. For example, indicia (24) may read as follows: “Detach mounting card (12) along perforation line (18). Detach patriotic bow (14) from the upper portion of mounting card (12). Attach patriotic bow (14) onto a surface of user choice. Detach strip (16) from the lower portion of mounting card (12) and attach it onto patriotic bow (14). Display this patriotic bow (14) proudly and do not remove strip (16) from patriotic bow (14) until justice has been rendered and all our troops are safely back in the arms of America.” It is to be noted if the user wishes to attach the mounting card (12) onto the internal surface of a window so as to be displayed outwardly there from, the user would attach strip (16) onto patriotic bow (14) before attaching the bow onto the support surface. Of course, the above instructions can be varied depending on the application relative thereto. For example, strip (16) may be left blank so as to allow the user to write the name of an honored loved one who is missed or who may be currently on active duty. If desired, when they are safely home the user may then remove the strip or leave it in place as a tribute to those loved and lost (16).

The present invention further includes a novel method of use as follows:

A method for using a novel display device (10) which is substantially in the form of a mounting card (12) having a removable symbol (14) and a removable strip (16) thereon, with the method comprising the steps of:

a. grasping mounting card (12);

b. grasping symbol (14) and manually removing symbol (14) from mounting card (12);

c. attaching symbol (14) onto a support surface (not shown);

d. grasping strip (16) and manually removing strip (16) from mounting card (12);

and;

e. attaching strip (16) onto symbol (14).

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatus's.

What we claim as new and wish to secure by Letters Patent is:

1. A novel display device comprising in combination: a mounting card; a symbol; and a strip; said mounting card having a front side and a back side, said front side being sectioned into an upper portion and a lower portion, said symbol having attachment means for removably attaching said symbol onto said upper portion of said mounting card and said strip having attachment means for removably attaching said strip onto said lower portion of said mounting card.

2. The novel display device of claim 1 further includes said mounting card being perforated between said upper portion and said lower portion.

3. The novel display device of claim 1 wherein said attachment means for removably attaching said symbol onto said upper portion of said mounting card is adhesive.

4. The novel display device of claim 1 wherein said attachment means for removably attaching said strip onto said lower portion of said mounting card is adhesive.

5. The novel display device of claim 1 wherein said mounting card, said symbol and said strip are each made from cardboard.

6. The novel display device of claim 1 wherein said symbol is in the form of a patriotic bow.

7. The novel display device of claim 1 wherein said strip includes indicia thereon which provides pertinent information relative to said symbol.

8. The novel display device of claim 1 wherein said symbol and said strip are made from a flexible magnetic material.

9. The novel display device of claim 1 wherein said symbol and said strip are made from an iridescent material.

10. The novel display device of claim 1 wherein said symbol and said strip are made from a fluorescent material so as to glow in the dark.

11. The novel display device of claim 1 wherein said backside includes indicia thereon which provides instructions for use of said mounting card.

12. A method for using a novel display device, said display device being in the form of a mounting card having a removable symbol and a removable strip thereon, with the method comprising the steps of:
a. grasping said mounting card;
b. grasping said symbol and manually removing said symbol from said mounting card;
c. attaching said symbol onto a support surface;
d. grasping said strip and manually removing said strip from said mounting card; and;
e. attaching said strip onto said symbol.
